(19) United States
(12) Patent Application Publication
(10) Pub. No.: US 2004/0243518 A1
(43) Pub. Date: Dec. 2, 2004

(54) Individual identity authentication system

(76) Inventors: John William Clifton, Marshall, MI (US); Paul Frank Guagliardo, Arlington Heights, IL (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/815,255

(22) Filed: Apr. 1, 2004

Related U.S. Application Data
(63) Continuation-in-part of application No. 10/437,652, filed on May 13, 2003.

(51) Int. Cl. G06F 17/60

(52) U.S. Cl. 705/72

(57) ABSTRACT

An individual identity authentication system for authenticating an identity of an individual includes a client computer system and a service provider computer system. The client computer system may be implemented at various locations, for example, airport terminals, so as to provide ready access for various users to authenticate the identity of a particular individual. The service provider computer system is in communication with the client computer system and executes code for causing the service provider computer system to perform a number of steps. One step includes receiving a personal identification number (PIN) and a social security number (SSN) of an individual that is entered into a secure terminal associated with the client computer system. Another step includes authenticating an identity of the individual when the entered PIN and the entered SSN correspond to a registered PIN and a registered SSN of the individual.

### CROSS REFERENCE TO RELATED APPLICATION

This application is a continuation-in-part of U.S. patent application Ser. No. 10/437,652, entitled “IDENTITY THEFT REDUCTION SYSTEM,” by John William Clifton et al., filed on May 13, 2003, the disclosure of which is hereby incorporated by reference herein in its entirety.

### BACKGROUND OF THE INVENTION

The present invention is generally directed to an authentication system and, more specifically, to an individual identity authentication system.

It is common practice for a creditor to request a credit report for an individual before extending credit to that individual. In a typical situation, a creditor requests a social security number (SSN) of the individual, at which point the creditor requests a credit report from one of any number of credit bureaus, e.g., consumer reporting agencies, such as Equifax™, Experian™ and TransUnion™. Upon receiving the credit report from a credit bureau, the creditor may then use the credit information contained in the credit report in determining whether to approve/disapprove entering into a financial transaction, for example, a loan, a rental agreement, a real estate agreement, etc., with the individual. However, when the individual seeking credit has assumed another individual's identity, the creditor may erroneously extend credit to the individual. This type of fraud may cost creditors hundreds of millions of dollars every year and can cause the individual whose identity has been stolen difficulty in obtaining future credit due to the fraud perpetuated upon the individual's identity.

A number of systems have been proposed and/or implemented to prevent unauthorized access to various consumer information. For example, U.S. Patent Application Publication No. 2003/0009435 discloses a centralized personal database that is accessible via the Internet and secured by a combination of identification numbers, including a basic, a primary and a secondary number. The secure personal database is accessible to a customer using a combination of the basic and primary numbers and is accessible to others who have been supplied with the basic number and a secondary number. In general, the primary and secondary numbers may be thought of as personal identification numbers (PINs).

As another example, U.S. Patent Application Publication No. 2002/0174067 discloses a tokenless electronic transaction system that uses a biometric sample of a buyer and an associated PIN to validate a buyer with a seller. As is disclosed, upon the determination of sufficient resources in a buyer's financial account, the financial account of the buyer is debited and a financial account of the seller is credited. The buyer initially registers with the system by providing at least one biometric sample and a PIN along with a financial account number.

The seller registers with the system by providing a seller financial account number. In performing a registration operation, an employee identifies himself/herself using a biometric sample and PIN when initially activating a registration system.

U.S. Patent Application Publication No. 2002/0143708 discloses a system for conducting secure credit card transactions over the Internet that prompts a consumer to enter a pre-registered PIN, which, together with a phone number from which the consumer is calling, is used to verify the identity of the consumer. The system implements software that selectively switches a consumer's computer connection from a merchant's web site on the Internet to a secured telephone line for accessing a freestanding server used to obtain authorization to make a purchase and then switches the consumer back to the merchant's web site once such authorization is obtained or denied. As is disclosed, a consumer may provide their social security number (SSN) for identification purposes.

U.S. Pat. No. 5,892,900 discloses a system that provides secure transaction management so as to maintain integrity, availability and/or confidentiality of information and processes related to the use of the information. The system tracks an individual's credit and generally protects the security of information related to the individual. The system also alternatively provides one or more passwords or other information used to identify or otherwise verify/authenticate an individual's identity. While the above-described systems attempt to limit the dissemination of an individual's personal information, these systems may fail to adequately safeguard the ability of one individual to assume the identity of another individual when seeking credit.

Additionally, it is increasingly desirable for various entities, for example, government entities, to be able to readily determine the identity of a particular individual. For example, government agencies and businesses have incorporated various devices, such as retinal scanners, fingerprint recognition and photo recognition systems at entrances of buildings or portions of buildings to limit the access to the buildings or portions of buildings to authorized personnel. However, such systems are typically very expensive and, as such, have only been implemented in limited high security situations.

What is needed is a system that reduces personal identity theft by ensuring that an individual who has applied for credit is legitimate before providing a potential creditor with a credit report on the individual. It would also be desirable to provide a system that economically and readily provides a means for authenticating the identity of a specific individual.

### SUMMARY OF THE INVENTION

According to one embodiment of the present invention, a technique for authenticating the identity of an individual includes a number of steps. One step includes receiving a personal identification number (PIN) and a social security number (SSN) of an individual. Another step includes authenticating the identity of the individual when the entered PIN and entered SSN correspond to a registered PIN and a registered SSN of the individual. It should be appreciated that this technique is particularly useful in that virtually all legal residents of the United States have an assigned SSN. According to another embodiment of the present invention, the technique includes registering the PIN of the individual with the SSN of the individual through a registration provider. According to one aspect of the invention, the registration provider includes banks and savings and loan associations. According to another embodiment of the present invention, the step of registering the PIN of the individual with the SSN of the individual through a registration provider includes a step of verifying the identity of the individual before providing the individual with access to a secure terminal for inputting the PIN and the SSN. According to a different aspect of the present invention, the identity of the individual is verified by an employee of the registration provider through examination of at least one of a drivers license, passport, SSN card, credit card and a birth certificate.

According to another embodiment of the present invention, the technique includes a number of other steps. One step includes monitoring authentication requests of the individual.

Another step includes flagging the individual when a number of failed authentication requests are above a predetermined level during a predetermined period. Yet another step includes notifying at least one of the registration provider and the individual of a potential identity theft when the associated authentication requests are above the predetermined level during the predetermined period. According to another aspect of the present invention, the secure terminal is connected to a service provider computer system that accesses a secure database to determine whether the entered PIN and the entered SSN correspond to a registered PIN and a registered SSN of the individual. According to a different aspect of the invention, the PIN may include numerals, characters, or a combination of numerals and characters, e.g., alphabetical symbols.

These and other features, advantages and objects of the present invention will be further understood and appreciated by those skilled in the art by reference to the following specification, claims and appended drawings.

### BRIEF DESCRIPTION OF THE DRAWINGS

FIG. 1 is an electrical block diagram of an exemplary private secured computer network;

FIG. 2 is an electrical block diagram of an exemplary computer network that utilizes the Internet;

FIG. 3 is a flow-chart of an exemplary entity set-up routine;

FIG. 4 is a flow-chart of an exemplary credit bureau routine;

FIG. 5 is a flow-chart of an exemplary credit report request routine; and

FIGS. 6A-6B are flow-charts of exemplary individual identity authentication routines.

### DETAILED DESCRIPTION OF PREFERRED EMBODIMENTS

As is described further herein, an identity theft reduction system designed according to the present invention reduces and/or eliminates personal identity theft by ensuring that an individual that applies for credit is, in fact, the individual who they represent themselves to be. According to one embodiment of the present invention, the identity theft reduction system is linked with a number of credit bureau computer systems and entity computer systems so as to allow an individual with a social security number (SSN) to assign a personal identification number (PIN), e.g., a 4 to 10 digit numeric and/or alphanumeric string, to their SSN. According to this embodiment, a credit bureau does not provide a credit report to a creditor unless the individual produces a valid PIN with the SSN.

According to another aspect of the invention, a technique for authenticating an identity of an individual is disclosed which can be implemented economically and which readily allows for authentication of the identity of a specific individual. It should be appreciated that virtually everyone legally present in the United States has an assigned social security number (SSN) that is readily available to that individual and which has typically been memorized by the individual. According to this aspect, each individual can register a personal identification number (PIN) in combination with their SSN to allow themselves to be uniquely identified in various places and under varying circumstances. According to one embodiment of the present invention, a registered PIN and SSN are stored in an encrypted form such that a PIN of an individual is protected from theft. According to this embodiment, the fact that the PIN is protected in an encrypted form ensures that an individual, whose identity is verified by a system constructed according to various embodiments of the present invention, is, in fact, who they claim to be. As is discussed above, implementing such a system provides a secure relatively low-cost system that adequately authenticates an identity of an individual under various circumstances and in a variety of different applications.

For example, in the financial industry, the system can be used to verify the identity of an individual for new accounts and loans, credit cards, large withdrawals, check cashing, safety deposit box access and cardless automatic teller machine (ATM) transactions. In the retail industry, the system can be interfaced with various retailers for identity checks for large purchases, rental agreements, cell phone services and over-the-counter credit card applications. In the airline industry, the system can be interfaced with airport security for automated identity checks. In the government agency area, the system can be used to verify the identity of an individual for immigration purposes (worldwide at U.S. embassies), government benefit offices, tax agencies and for homeland security purposes. In a corporate setting, the system provides a way for an affiliated company to verify the identity of new hires, allow human resource departments to verify the identity of an individual for tax purposes and to provide security for employees accessing facilities of a given company. In the Internet industry, the system provides a means for authenticating the identity of an individual undertaking an Internet transaction. In the medical industry, the system can be utilized to authenticate the identity of someone making a healthcare benefit claim. In the law enforcement area, the system readily provides a means for authenticating the identity of people who have been incarcerated. According to one aspect of the present invention, various entities utilizing the service can use a secure workstation that is interfaced to the Internet to access a service provider computer system accessible database to authenticate the identity of a user. For example, a secure keypad associated with a workstation may be provided to allow an individual to enter their PIN and SSN, after the PIN and SSN have been registered with the system. Upon verifying the PIN and SSN of the individual, the system then provides the name of the individual (and potentially may provide other information) to the workstation for display to an individual who is contemplating some sort of transaction with the individual. It is further contemplated that the system may be interfaced with building security systems to control employee access to facilities and may also be used as an interface with credit bureau systems to provide access to, for example, credit bureau reports. It should be appreciated that a registration process, similar to that described below, is necessary to verify the identity of a person and then to allow them to enter a PIN for registration with the service provider.

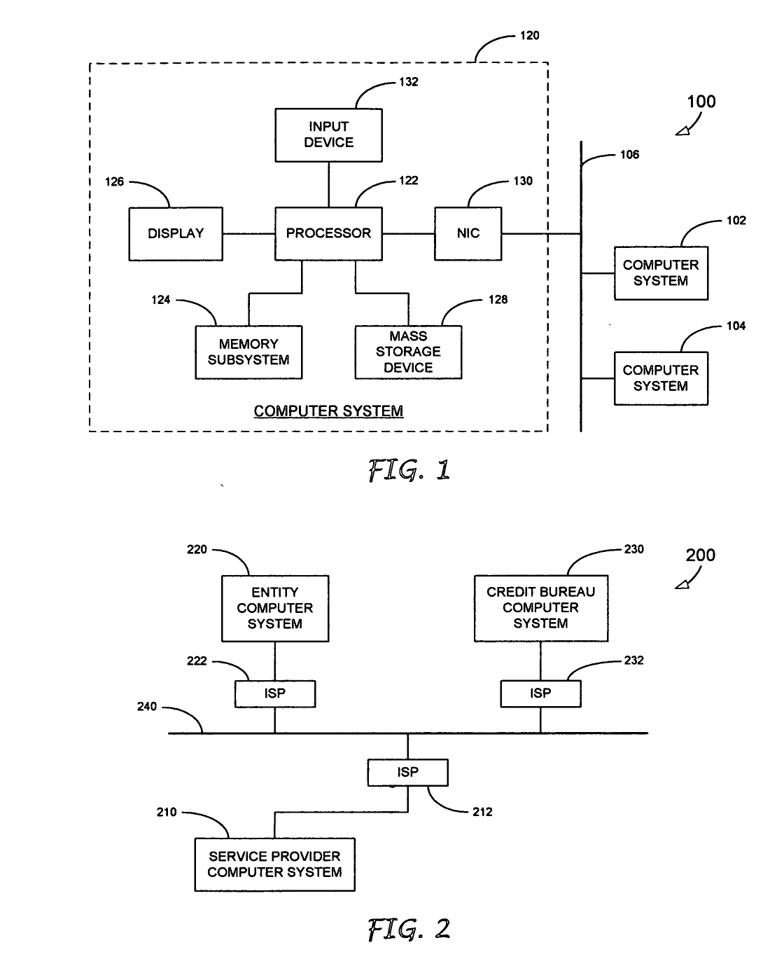

FIG. 1 depicts an exemplary computer network 100 that includes three computer systems 102, 104 and 120, which are coupled to a private secured communication link 106. The computer system 120, which is exemplary of the computer systems 102 and 104, includes a processor 122 that is coupled to a mass storage device 128, a memory subsystem 124, a display 126, an input device 132 and a network interface card (NIC) 130. The memory subsystem 124 includes an application appropriate amount of volatile and non-volatile memory and the mass storage device 128 is utilized to store one or more databases that may be utilized by the service provider computer system 120, which is programmed according to the various embodiments of the present invention.

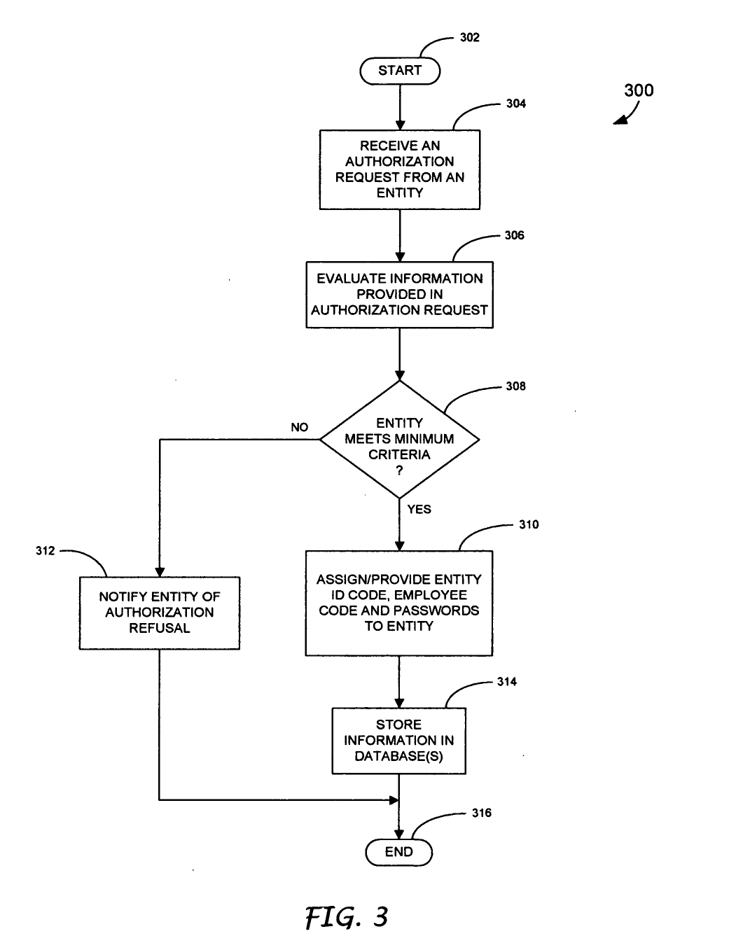

FIG. 2 depicts an exemplary computer network 200 that includes computer systems 210, 220 and 230 that are capable of communicating with each other over an Internet connection 240, via Internet service providers (ISPs) 212, 222 and 232, respectively. As an example, when an individual approaches an authorized entity to set-up an account with the identity theft reduction and/or individual identity authentication service provider, an employee of the entity, utilizing the computer system 220, communicates with the service provider computer system 210, via the Internet 240 and the ISPs 212 and 222. The identity theft reduction and/or individual identity authentication services may be offered through a qualified financial institution and/or other entity that meets minimum requirements for proof of identity. In this manner, an authorized financial institution and/or other entity can offer the identity theft reduction and/or individual identity authentication services to any of its customers.

According to this embodiment, an employee of an approved entity, such as a loan officer or interviewer, provides customer registration information to the service provider for each customer. This information can be provided in various ways, such as through a paper or electronic form. In one embodiment, the form would require an entity identification number, an employee code, the individual's SSN and a PIN. The PIN may be selected by the customer and may be of varying lengths and include numerals, characters or a combination of numerals and characters. The form is then electronically provided to the service provider computer system 210 through a secured interface. According to another embodiment of the present invention, the employee may provide the information via a voice interface. It should be appreciated that the employee of an authorized financial institution may verify the identity of a customer through examination of at least one of a drivers license, a passport, an SSN card, a credit card, a birth certificate and/or other identification means.

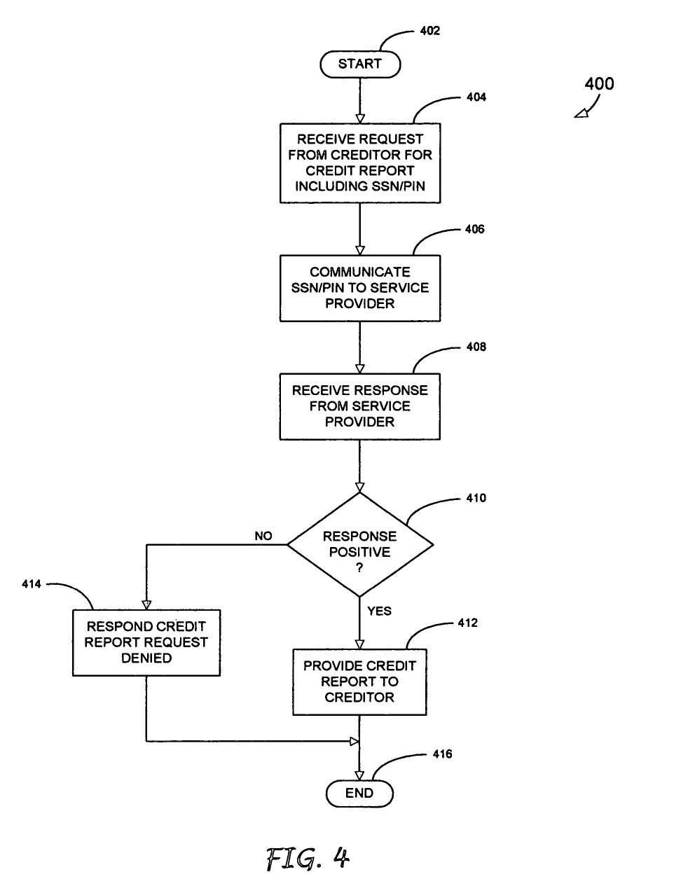

An exemplary entity set-up routine 300 is further depicted in FIG. 3. In step 302, the routine 300 is initiated, at which point control transfers to step 304, where the computer system 210 receives an authorization request from an entity, via, for example, the computer system 220. Next, in step 306, the system 210 evaluates the information provided in the authorization request to determine whether the entity meets the minimum criteria to become an approved entity. Then, in decision step 308, the system 210 determines whether the entity has met the minimum criteria and, if so, control transfers to step 310.

If the entity does not meet the minimum criteria in step 308, control transfers to step 312, where a communication is sent to the entity notifying the entity of authorization refusal, at which point control transfers to step 316, where the routine 300 terminates. In step 310, after establishing that the entity meets the minimum criteria in step 308, the system 210 assigns entity identification codes, employee codes and passwords to the entity and securely communicates the information to the entity. Next, in step 314, the system 210 stores the information in one or more databases before the routine 300 terminates in step 316.

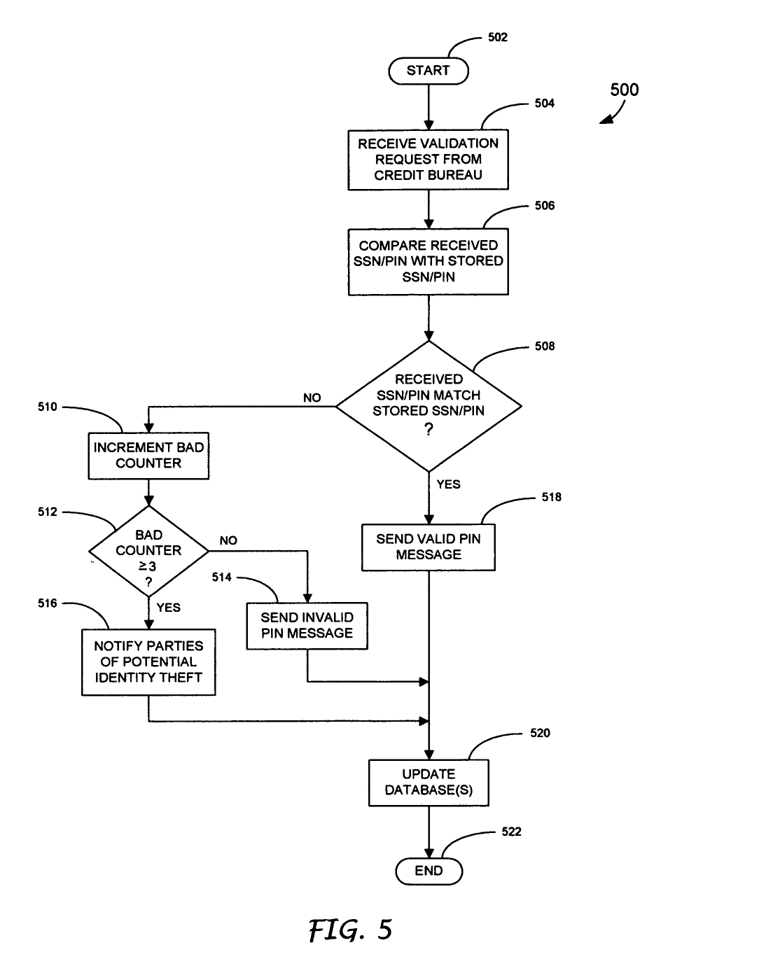

With reference to FIG. 4, a credit bureau routine 400 is further depicted. The routine 400 is designed to be executed on a credit bureau computer system, e.g., the computer system 230, which is coupled to Internet 240 through the ISP 232. In step 402, the routine 400 is initiated, at which point control transfers to step 404, where the computer system 230 receives a request that includes an encrypted combination SSN and PIN from, for example, the creditor computer system 220. Next, in step 406, the computer system 230 communicates the SSN/PIN to the service provider computer system 210 via, for example, a secure Internet connection.

Then, in step 408, the computer system 230 receives a response from the service provider computer system 210.

Next, in decision step 410, the computer system 230 determines whether the response was a positive response. If the response was a positive response, control transfers from step 410 to step 412. If the response is not a positive response, control transfers from step 410 to step 414, where the computer system 230 provides a message to the computer system 220, indicating that the credit report requested is denied, at which point control transfers to step 416, where the routine 400 terminates. In step 410, when a positive response is received, control transfers to step 412, where the computer system 230 causes a credit report to be provided to the creditor. This may be achieved by causing a report for the individual to be printed and mailed to the creditor and/or an electronic transfer of the credit report may take place. In step 412, control transfers to step 416, where the routine 400 terminates.

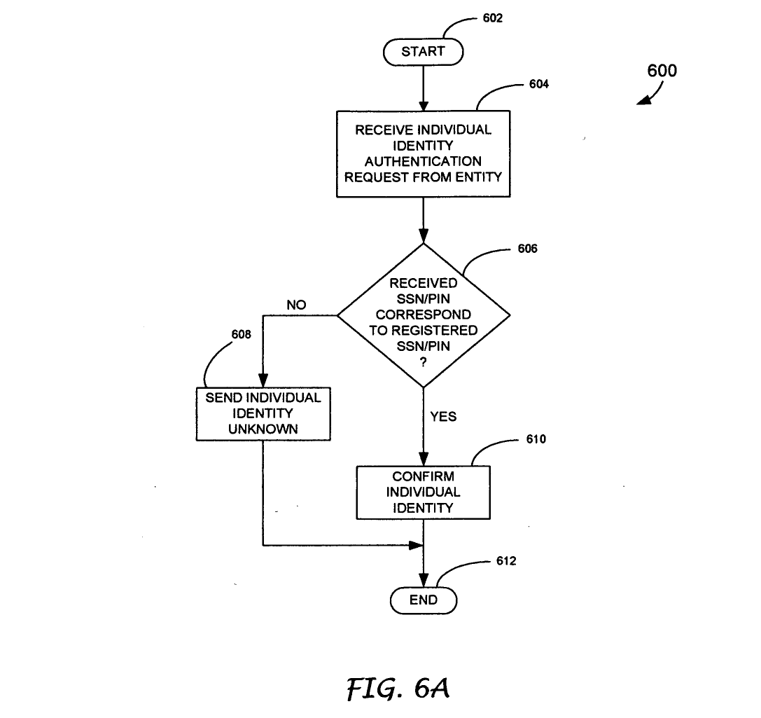

With reference to FIG. 5, an exemplary credit report request routine 500 is shown. The routine 500 is initiated in step 502, at which point control transfers to step 504, where the computer system 210 receives a validation request from the credit bureau computer system 230. Next, in step 506, the computer system 210 compares the received SSN/PIN with a stored SSN/PIN to determine if a match occurs. It should be appreciated that the database that contains the stored SSN/PIN pairs may also be encrypted. Then, in decision step 508, the computer system 210 determines whether the received SSN/PIN matches a stored SSN/PIN. If so, control transfers from step 508 to step 518, where the computer system 210 sends a valid PIN message to the credit bureau computer system 230. Next, in step 520, the computer system 210 updates an appropriate database or databases before the routine 500 terminates in step 522.

In step 508, when the computer system 210 determines that the received SSN/PIN does not match the stored SSN/PIN, control transfers to step 510. In step 510, the computer system 210 causes a counter, e.g., a BAD counter, to be incremented, at which point control transfers to decision step 512. In step 512, the computer system 210 determines whether the BAD counter is greater than or equal to a predetermined value, e.g., 3. If so, control transfers to step 516, where the computer system 210 notifies the parties, e.g., the entity, credit bureaus, authorities and the individual whose SSN has been supplied, of a potential identity theft before transferring control to step 520. In step 520, the routine 500 updates an appropriate database or databases before transferring control to step 522. In step 512, when the BAD counter is less than 3, control transfers to step 514, where the computer system 210 causes an invalid PIN message to be sent to the credit bureau computer system 230, before transferring control to step 520 for updating appropriate databases and termination of the routine in step 522.

It should be appreciated that the communication link between the computer systems 210, 220 and 230 may be achieved through an application program interface (API) via a secure Internet link. Using a static TCP/IP address, a reasonable security level may be achieved.

Further, it may desirable that each employee of the credit bureau be provided with an initial login ID and password to begin a session with the service provider computer system 210. It should be appreciated that the initial set-up of the individual PINs may be achieved through an audio system located in a secure environment that prompts an employee of an entity for an entity number, an employee code and a password, as well as an SSN and a PIN for an individual who desires to secure their SSN.

It should also be appreciated that the service provider computer system 210 may implement one or more databases. For example, the computer system 210 may implement an encrypted SSN/PIN database, an encrypted entity database, a secure credit bureau database and a secure encrypted access history database. The SSN/PIN database may be utilized to store the SSNs and PINs for individuals who have signed up for the service. Further identification information, such as name, address, challenge phrase and passcode, may also be included in the SSN/PIN database. The financial institution database may include information for qualifying entities offering the service. In addition, the entity database may include identification numbers for each of the entities along with associated employee codes and passwords that are used to add new PINs. The credit bureau database houses information for participating credit bureaus and the access history database may be utilized to track access to the service provider computer system 210. In this manner, information can be stored that allows for monitoring excessive accesses and notifying individuals or entities of a potential problem. As is discussed above, upon, for example, a third attempt to obtain a credit report using an SSN and an invalid PIN, the computer system 210 may automatically lock the account and notify affected credit bureaus, authorized entities and government authorities of a potential identity theft. Further, an individual whose identity is being stolen may also be notified and/or local authorities may be notified that a potential identity theft is in progress. Additionally, as is described above, an entity can readily add a PIN for a customer's SSN through an audio interface system and the financial institution can also request a credit report with the assigned PIN.

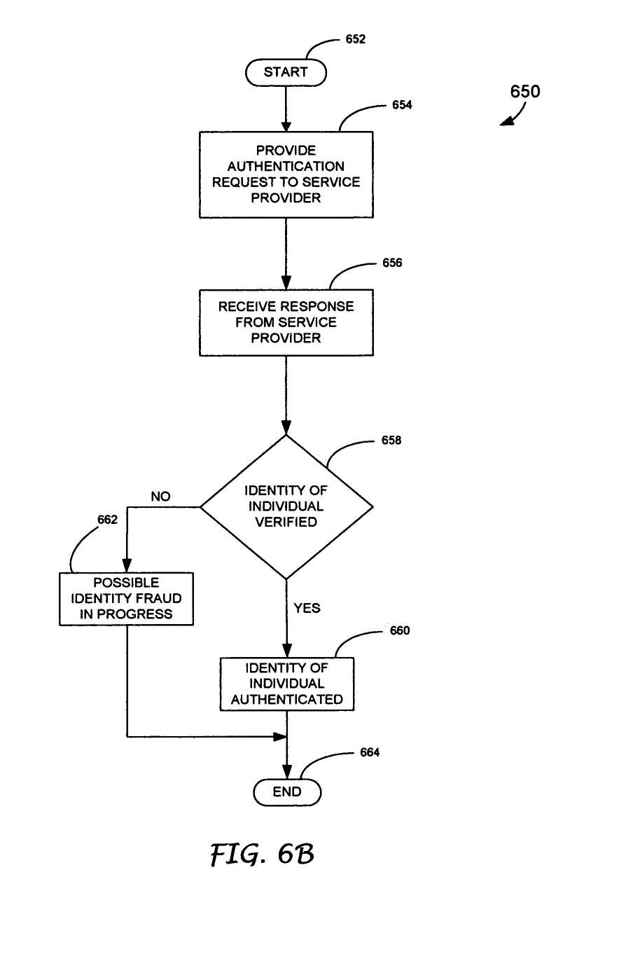

With reference to FIG. 6A, a flow-chart of an exemplary individual identity authentication routine 600 is illustrated, which is executed on the service provider computer system 210. In step 602, the routine 600 is initiated, at which point control transfers to step 604, where the service provider computer system 210 receives an individual identity authentication request from an entity including a social security number (SSN) and an associated PIN of an individual through the entity computer system 220. Next, in decision step 606, the system 210 determines whether the received SSN/PIN corresponds to a registered SSN/PIN. If so, control transfers from step 606 to step 610, where the system 210 sends a message to the entity computer system 220 confirming the individual's identity, at which point control transfers to step 612. In step 606, if the received SSN/PIN does not correspond to a registered SSN/PIN, control transfers to step 608, where the system 210 sends an individual identity unknown message to the entity computer system 220 before the routine 600 terminates in step 612. It should be appreciated that the system 210 may also implement a routine, similar to that disclosed with reference to FIG. 5, that tracks when a received SSN/PIN does not correspond to a stored SSN/PIN and notifies appropriate parties of a potential identity theft.

With reference to FIG. 6B, another exemplary individual identity authentication routine 650 is illustrated that is executed on the entity computer system 220. In step 652, the routine 650 is initiated, at which point control transfers to step 654, where the entity computer system 220 provides an authentication request to the service provider computer system 210. Next, control transfers to step 656, where the entity computer system 220 receives a response from the service provider computer system 210. Then, in decision step 658, the entity computer system 220 determines whether the identity of the individual is verified. If so, control transfers from step 658 to step 660, where the entity computer system 220 provides an indication that the identity of the individual is authenticated before providing a name of the individual to the entity and transferring control to step 664, where the routine 650 terminates. If the identity of the individual is not verified in step 658, control transfers to step 662, where the entity computer system provides an alert that a possible identity fraud is in progress before providing a name of the individual assigned to the SSN/PIN and transferring control to step 664.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

The invention claimed is:

1. A method for authenticating an identity of an individual, comprising the steps of:
receiving a personal identification number (PIN) and a social security number (SSN) of an individual; and
authenticating an identity of the individual when the received PIN and the received SSN correspond to a registered PIN and a registered SSN of the individual.

2. The method of claim 1, further comprising the step of:
registering the PIN of the individual with the SSN of the individual through a registration provider.

3. The method of claim 2, wherein the registration provider includes banks and savings and loan associations.

4. The method of claim 2, wherein the step of registering the PIN of the individual with the SSN of the individual through a registration provider includes the step of:
verifying an identity of the individual before providing the individual with access to a secure terminal for inputting the PIN and the SSN.

5. The method of claim 4, wherein the identity of the individual is verified by an employee of the registration provider through examination of at least one of a drivers license, a passport, an SSN card, a credit card and a birth certificate.

6. The method of claim 2, further including the steps of:
monitoring authentication requests for the individual;
flagging the individual when the number of failed authentication requests are above a predetermined level during a predetermined period; and
notifying at least one of the registration provider and the individual of a potential identity theft when the associated authentication requests are above the predetermined level during the predetermined period.

7. The method of claim 4, wherein the secure terminal is connected to an entity computer system that is in communication with a service provider computer system, and wherein the service provider computer system accesses a secure database to determine whether the entered PIN and the entered SSN correspond to a registered PIN and a registered SSN of the individual.

8. The method of claim 1, wherein the PIN includes one of numerals, characters and a combination of numerals and characters.

9. A system for authenticating an identity of an individual, comprising:
a service provider computer system in communication with an entity computer system, the service provider computer system storing code that when executed by the service provider computer system instructs the service provider computer system to perform the steps of:
receiving a personal identification number (PIN) and a social security number (SSN) of an individual from the entity computer system; and
authenticating an identity of the individual by sending an individual identity authentication message to the entity computer system when the received PIN and the received SSN correspond to a registered PIN and a registered SSN of the individual.

10. The system of claim 9, wherein the service provider computer system includes additional code for instructing the service provider computer system to perform the additional step of:
registering the PIN of the individual with the SSN of the individual through a registration provider.

11. The system of claim 10, wherein the registration provider includes banks and savings and loan associations.

12. The system of claim 10, wherein the step of registering the PIN of the individual with the SSN of the individual through a registration provider only occurs after the registration provider verifies the identity of the individual.

13. The system of claim 12, wherein the identity of the individual is verified by an employee of the registration provider through examination of at least one of a drivers license, a passport, an SSN card, a credit card and a birth certificate.

14. The system of claim 10, wherein the service provider computer system includes additional code for instructing the service provider computer system to perform the additional steps of:
monitoring authentication requests for the individual;
flagging the individual when the number of failed authentication requests are above a predetermined level during a predetermined period; and
notifying at least one of the registration provider and the individual of a potential identity theft when the associated authentication requests are above the predetermined level during the predetermined period.

15. The system of claim 9, wherein the service provider computer system accesses a secure database to determine whether the received PIN and the received SSN correspond to a registered PIN and a registered SSN of the individual.

16. The system of claim 9, wherein the PIN includes one of numerals, characters and a combination of numerals and characters.

17. A system for authenticating an identity of an individual, comprising:
a service provider computer system in communication with an entity computer system, the service provider computer system storing code that when executed by the service provider computer system instructs the service provider computer system to perform the steps of:
registering a personal identification number (PIN) of an individual with a social security number (SSN) of the individual through a registration provider.
receiving the PIN and the SSN of the individual from the entity computer system; and
authenticating an identity of the individual by sending an individual identity authentication message to the entity computer system when the received PIN and the received SSN correspond to a registered PIN and a registered SSN of the individual.

18. The system of claim 17, wherein the registration provider includes banks and savings and loan associations.

19. The system of claim 17, wherein the service provider computer system includes additional code for instructing the service provider computer system to perform the additional steps of:
monitoring authentication requests for the individual;
flagging the individual when the number of failed authentication requests are above a predetermined level during a predetermined period; and
notifying at least one of the registration provider and the individual of a potential identity theft when the associated authentication requests are above the predetermined level during the predetermined period.

20. The system of claim 17, wherein the service provider computer system accesses a secure database to determine whether the entered PIN and the entered SSN correspond to a registered PIN and a registered SSN of the individual.

21. The system of claim 17, wherein the PIN includes one of numerals, characters and a combination of numerals and characters.
